(19) United States
(12) Patent Application Publication
(10) Pub. No.: US 2016/0364562 A1
(43) Pub. Date: Dec. 15, 2016

(54) SYSTEMS AND METHODS FOR SYSTEM SELF-CONFIGURATION

(71) Applicant: Pure Storage, Inc., Mountain View, CA (US)

(72) Inventors: John Hayes, Mountain View, CA (US); Par Botes, Mountain View, CA (US); John Colgrove, Mountain View, CA (US)

(21) Appl. No.: 14/734,889

(22) Filed: Jun. 9, 2015

(51) Int. Cl. G06F 21/34; G06F 21/35

(52) U.S. Cl. CPC G06F 21/34; G06F 21/35

(57) ABSTRACT

A method for storage array self-configuration is disclosed. The method includes accessing an authenticated token that comprises encrypted configuration data for a storage array, decrypting the configuration data, and based on the configuration data, executing with configuration executing components of the storage array a configuration of the storage array. The configuration is executed responsive to an authentication of the token.

### BACKGROUND

In computers and computer networks, a configuration often refers to the specific hardware and software details, related to devices that are attached thereto, the capacity or capability of the system, and exactly of what the system is composed. In installing hardware and software, configuration can entail the methodical process of defining options that are provided. In particular, hardware configuration involves defining options related to hardware details and system resource settings allotted for a specific device.

In conventional practice, technicians can be employed to perform configurations. The technicians can be provided with passwords that are used for configuration purposes. However, conventional configuration processes can be undesirable as such processes can present significant risks.

Risks involved can include, the loss of passwords and the access to passwords by systems or personnel (rack and stack people) in the installation process who are different from the people involved in sales or on-going administration. Moreover, passwords don't lend themselves to simple re-installation and re-configuration. For example, in conventional configuration processes, re-installation and re-configuration typically require people who are different from those involved in the initial installment and configuration to re-issue passwords and/or re-initialize the system to stem states.

It is in this context in which the present embodiments arise.

### SUMMARY

Conventional configuration processes can present significant risks such as a loss of the initial passwords and the access to the passwords by undesired systems or people. A method for storage array self-configuration is disclosed that addresses the aforementioned shortcomings of conventional technologies. However, the claimed embodiments are not limited to implementations that address any or all of the aforementioned shortcomings. The method includes accessing an authenticated token that comprises encrypted configuration data for a storage array, decrypting the configuration data, and based on the configuration data, executing with configuration executing components of the storage array a configuration of the storage array. The configuration is executed responsive to an authentication of the token. The method enables an avoidance of the significant risks that are posed by events such as a loss of a password, and, circumstances such as the accessibility to passwords by systems or people not desired to have such access.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A shows an exemplary operating environment of a system for storage array self-configuration according to one embodiment.

FIG. 1B illustrates the operation of a system for storage array self-configuration according to one embodiment.

FIG. 2 shows components of a system for storage array self-configuration according to one embodiment.

FIG. 3 shows a flowchart of a method for storage array self-configuration according to one embodiment.

FIG. 4 is an illustration showing an exemplary computing device which may implement the embodiments described herein.

### DETAILED DESCRIPTION

In the following detailed description, numerous specific details such as specific method orders, structures, elements, and connections have been set forth. It is to be understood however that these and other specific details need not be utilized to practice embodiments of the present invention. In other circumstances, well-known structures, elements, or connections have been omitted, or have not been described in particular detail in order to avoid unnecessarily obscuring this description.

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals of a computer readable storage medium and are capable of being stored, transferred, combined, compared, and otherwise manipulated in a computer system. It has proven convenient at times, principally for reasons of common usage, to refer to these signals as bits, values, elements, symbols, characters, terms, numbers, or the like.

References within the specification to “one embodiment” or “an embodiment” are intended to indicate that a particular feature, structure, or characteristic described in connection with the embodiment is included in at least one embodiment of the present invention. The appearance of the phrase “in one embodiment” in various places within the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing” or “decrypting” or “executing” or the like, refer to the action and processes of a computer system, or similar electronic computing device that manipulates and transforms data represented as physical (electronic) quantities within the computer system's registers and memories and other computer readable media into other data similarly represented as physical quantities within the computer system memories or registers or other such information storage, transmission or display devices.

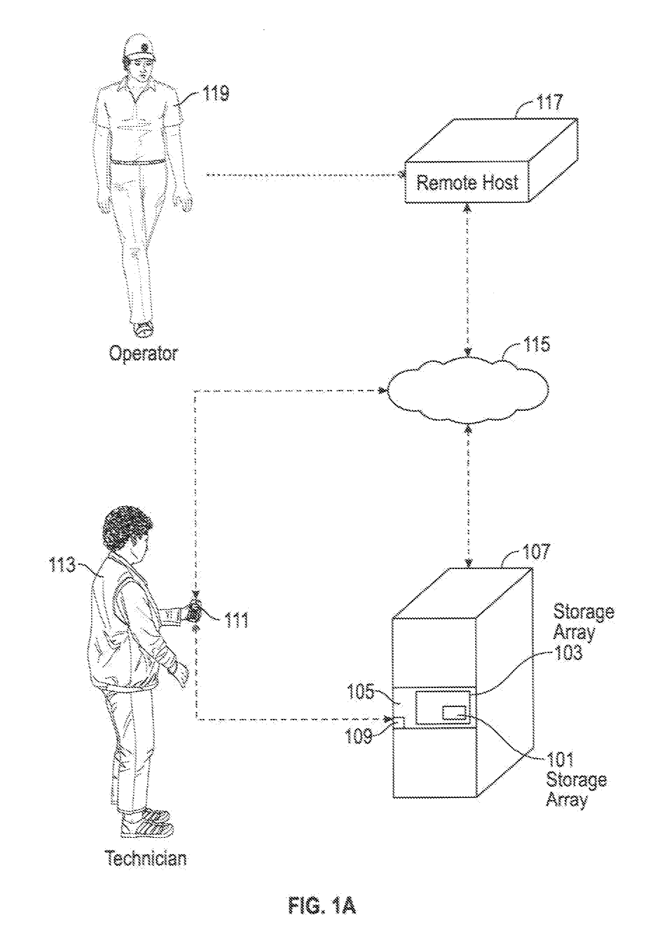

FIG. 1A shows an exemplary operating environment 100 of system 101 for storage array self-configuration according to one embodiment. System 101 accesses configuration data and based on the configuration data executes a self-configuration of a storage array 103. System 101 enables the avoidance of the significant risks that are posed by events such as a loss of an initial password, and, circumstances such as the accessibility to passwords by undesired systems or people. In the FIG. 1A embodiment, operating environment 100 can include system 101, storage array 103, rack mounted appliance 105, rack of arrays 107, audio jack 109, electronic device 111, technician 113, internet 115, remote host 117 and operator 119.

Still referring to FIG. 1A, storage array 103 is a data storage device that may use integrated circuit array assemblies as memory to store data. In some embodiments, storage array 103 may contain solid state arrays, hard disk drives, or combinations of the two. It should be appreciated that the embodiments are not limited to a storage array as this is one example and not meant to be limiting. The embodiments may be extended to any device having to be configured for installation or reconfigured after installation. Prior to its initial use, storage array 103 undergoes a configuration process. It should be appreciated that storage array 103 can undergo a re-configuration process subsequent to its initial use. In one embodiment, storage array 103 is designed such that it can be self-configured upon authentication of a token that is associated with the configuration data. In the FIG. 1A embodiment, storage array 103 includes system 101 which accesses configuration data and performs the configuration of storage array 103. Storage array 103 may be a part of a rack mounted appliance 105 that is mounted in a rack cabinet 107. In one embodiment, rack mounted appliance 105 can include audio jack 109 that is a communications device that can receive and transmit data. Audio jack 109 may incorporate the four conductor TRRS (Tip Ring Ring Sleeve) analog phone connector. Alternative connectors that are analog or digital may be utilized with the embodiments as the TRRS connector is one example. In addition, the connection may be wired or wireless in some embodiments. In some embodiments, audio jack 109 may be integrated into storage array 103 as the embodiment illustrated in FIG. 1A is meant to be one example of an operating environment.

An automated self-configuration of storage array 103 can be initiated by technician 113. As noted above the embodiments may be extended to a re-start of the storage array after a power loss or other type of failure, as well as an initial configuration. An application that facilitates the initiation of such an automated self-configuration of storage array 103 can be accessed (e.g., downloaded onto electronic device 111) by technician 113 from remote host 117. In one embodiment, the application can be accessed from a website or a cloud assistance service. An identifier of the array that is to be configured can be selected by technician 113 after login to remote host 117 in some embodiments. Configuration data corresponding to the selected array can then be obtained and when the array has been racked and stacked, technician 113 can establish a connection between storage array 103 and electronic device 111. An inventory of storage array 103 can be obtained with the option to upload configuration data. In one embodiment, when the configuration data is uploaded and executed by storage array 103, the storage array can report a pass/fail condition through an application executing on electronic device 111. The connection to storage array 103 may be through an audio jack connection of the storage array and the electronic device 111, however, alternative connections that are wired or wireless may be integrated with the embodiments. In some embodiments the electronic device is a cellular phone, however, electronic device 111 may be any portable electronic device, such as a tablet, laptop, etc. It should be appreciated that the mobile electronic device substitutes for a “crash cart” and eliminated the need to directly connect a monitor and keyboard of the “crash cart” directly to the server or device being configured. It should be further appreciated that audio jack 109 is being utilized as a data bus and not a peripheral bus. Thus, utilization of audio jack 109 in this manner enables system configuration via the audio jack, secure identification through the audio jack, utilizing an audio tunnel in multi-factor identification, separate control and data channels over an audio connection, e.g., use of the four conductor TRRS connector, network tunnel configuration over an audio tunnel, among other applications.

Electronic device 111 is used to access configuration data from remote host 117 (or from another source such as a website or cloud assistance service of the provider of the storage array or rack mounted appliance as discussed above) and to transmit the configuration data via a token, to system 101. As mentioned above, electronic device 111 can include any devices suitable for receiving and transmitting data. The token may be authenticated through any known authentication process. For example, the authentication of the token may be a single factor or a multiple factor authentication process in some embodiments. In some embodiments the token may be encrypted and after the token has been decrypted, the configuration data that is carried by the token can be used to configure storage array 103. The configuration data can be encrypted locally (on electronic device 111) or the configuration data can be encrypted before being accessed by electronic device 111. System 101 accesses the authenticated token that includes the configuration data for storage array 103 and executes a configuration of storage array 103 utilizing configuration executing components of system 101. System 101 can decrypt the configuration data through decryption logic contained on storage array 103. In one embodiment, the execution of the configuration of storage array 103 can be automatically initiated in response to the authentication of the token.

The authenticated token includes encrypted data that determines a level of access to the storage array (e.g., role based access to the storage array). That is, after the token is authenticated, role based authorization occurs in some embodiments. For example, various levels of access such as an administrator having full access to a very limited type of access are able to be provided through the embodiments. The level of access for a user may be referred to as defining a role for a user. In some embodiments, a role may contain privileges that define a set of actions that can be performed within an organization, i.e., the privileges can define the access level for the role. For example, a salesperson role is assigned a set of privileges that are relevant to the performance of the tasks defined for that role. Similarly, a human resources role or Information Technology role may be assigned certain privileges. It should be appreciated that in some embodiments a user may be assigned to one or more roles. In one embodiment, the configuration data and the data that determines the level of access to the storage array are decryptable together or separately. The accessing of the token from a portable token acquiring and delivery system (e.g., a portable electronic device) may be triggered by detecting when the token is within a predetermined range of the storage array 103. In one embodiment, the accessing includes receiving the authenticated token via an audio jack 109. Thus, the embodiments may utilize the audio jack 109 to transmit the encrypted configuration data that determines a level of access for a technician performing the configuration. In one embodiment, the token is a temporal token and expires after a predetermined period of time. The configuration process may be updatable based on information included in the configuration data is some embodiments. For example, the configuration process may determine if revisions to the configuration have been applied and whether additional updates to the configuration are necessary by checking with the remote host or through the cloud assistant service. If a later revision or update is available, the configuration could be updated as part of the configuration process. Referring again to FIG. 1A, in one embodiment, system 101 can be a component of storage array 103 that is a part of a rack mounted appliance 105 and mounted in rack cabinet 107. Remote host 117 stores configuration data and provides the encrypted configuration data via tokens to the electronic devices 111 of technician 113. In one embodiment, remote host 117 can be operated by remote host operator 119. Operator 119 may have administrator level access and set up the configuration for the storage array 103 to be downloaded by technician 113 through electronic device 111.

FIG. 1B illustrates the operation of system 101 for storage array self-configuration according to one embodiment. These operations, which relate to storage array self-configuration, are only exemplary. Moreover, it should be appreciated that other operations not illustrated in FIG. 1B can be performed in accordance with one embodiment. Referring to FIG. 1B, at A, configuration data 117a is prepared and stored for later retrieval. In one embodiment, the configuration data 117a can be encrypted and stored at storage sites that can include but are not limited to remote hosts, cloud assistance services and websites. In another embodiment, the configuration data 117a is stored unencrypted and later encrypted at various time points as discussed herein. Operator 119 of FIG. 1A may control the preparation and or storage of the configuration data within remote host 117. At B in FIG. 1B, the configuration data 117a is downloaded to an electronic device 111 of an authorized technician and packaged as a part of a token 117b. In one embodiment, the configuration data can be encrypted before it is downloaded to the electronic device. In other embodiments the configuration data can be encrypted after it is downloaded to the electronic device. At C, token 117b including the encrypted configuration data is transmitted to storage array 103. As shown in FIG. 1B, the token 117b can be transmitted from the electronic device to the storage array 103 via audio jack 109. In other embodiments the token 117b can be transmitted to the storage array 103 via any other suitable wired or wireless transmission mechanism. A proximity detector within the storage array may detect presence of the token 117b in some embodiments to initiate the self-configuration.

Still referring to FIG. 1B, at D, the encrypted configuration data associated with the authenticated token is decrypted. The decryption logic is integrated into storage array 103 and/or system 101 in some embodiments. In addition, authentication logic integrated into storage array 103 or appliance 105 may perform the authentication of token 117b. At E, the configuration data is accessed by the configuration component of system 101 for storage array self-configuration, and a self-configuration of storage array 103 is executed. It should be appreciated that the configuration data may initialize the storage array 103 to the functional specifications requested by the owner/buyer of the storage array. In addition, the embodiments may be utilized to re-start the storage array after a power interruption or other type of system failure or crash. It should be appreciated that the embodiments may be extended to hardware service and any upgrades whether hardware or software. Upon completion of the self-configuration, storage array 103 is available for use by the owner/buyer of the storage array. Alternatives to the embodiments described herein may be readily devised. For example, the token communicated to the storage array 103 may unlock configuration data stored on the storage array itself for the self-configuration upon authentication of the token by the storage array. In other embodiments, the token may initiate downloading the configuration from remote host 117 through a secure connection with the storage array 103 upon authentication of the token.

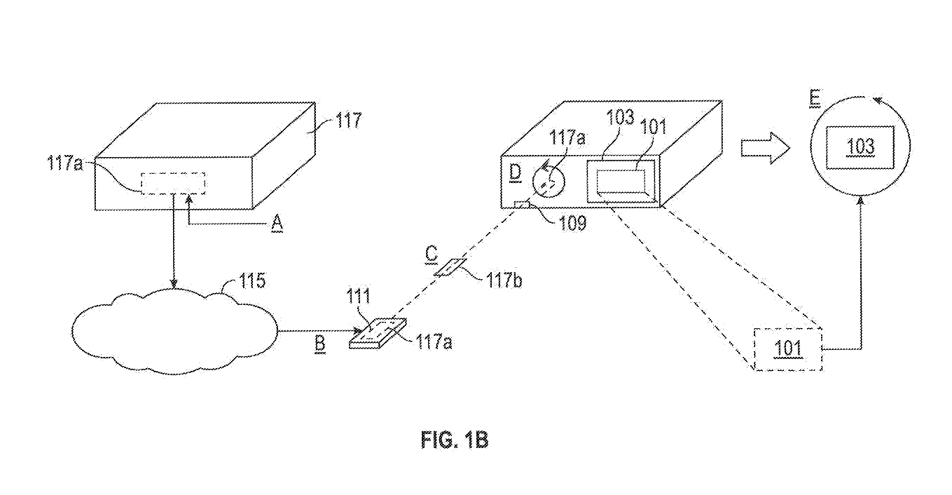

FIG. 2 shows components of a system 101 for storage array self-configuration according to one embodiment. In one embodiment, the components of system 101 for storage array self-configuration implement an algorithm for storage array self-configuration. In the FIG. 2 embodiment components of system 101 include token accessing component 201, proximity detector 201a and configuration executing component 203. In some embodiments, system 101 includes a decryption module. Token accessing component 201 accesses an authenticated token that includes encrypted configuration data for a storage array. In one embodiment, token accessing component 201 can access the authenticated token from an electronic device 111 that obtains stored configuration data and transmits the configuration data wrapped or packaged in the token, to system 101. As noted above, the electronic device 111 can be a smart phone or other suitable portable electronic device capable of receiving and transmitting data. In some embodiments, electronic device 111 may include a mobile application associated with the cloud assistance service of the provider of the storage array to assist with the self-configuration. Proximity detector 201A determines whether or not the electronic device 111 is within range of the storage array. In one embodiment, proximity detector 201A indicates to token accessing component 201 that an authenticated token is accessible when proximity detector 201A determines that the electronic device is within a certain range of the storage array 103. Proximity detector may operate under known wireless communication standards between devices such as Bluetooth, Near Field Communication, etc. Configuration executing component 203 executes a configuration of the data storage array based on the configuration data that is obtained from the authenticated token. In one embodiment, the configuration is triggered responsive to detecting the authenticated token. The configuration may be embodied as a bit stream in some embodiments. It should be appreciated that the configuration may specify resources to be utilized by the storage array as well as specifying other operating mechanisms.

Access determining component 205, which is optional, determines the level of access that is granted to the data storage array. In one embodiment, the level of access to the data storage array can be based on encrypted data associated with the token that indicates a level of access that should be granted for a particular user or technician. The level of access that is granted can range from limited access, e.g., a rack and stack employee, to unlimited access, e.g., an administrator. In one embodiment, the level of access can be role based (the role that an individual has determines his/her level of access as mentioned above). It should be appreciated that the aforementioned components of system 101 can be implemented in hardware or software or in a combination of both, e.g., as firmware. In one embodiment, components and operations of system 101 can be encompassed by components and operations of one or more computer components (e.g., data storage array 103). In another embodiment, components and operations of system 101 can be separate from the aforementioned one or more computer components but can operate cooperatively with components and operations thereof.

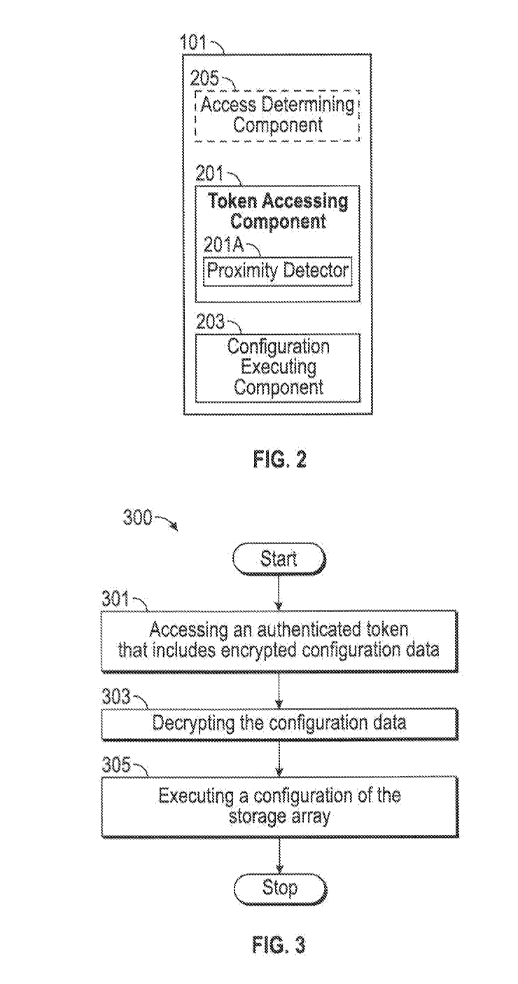

FIG. 3 shows a flowchart 300 of a method for storage array self-configuration according to one embodiment. The flowchart includes processes that, in one embodiment can be carried out by processors and electrical components under the control of computer-readable and computer-executable instructions. Although specific steps are disclosed in the flowcharts, such steps are exemplary. That is, the present embodiment is well suited to performing various other steps or variations of the steps recited in the flowchart. Referring to FIG. 3, at 301, an authenticated token is accessed that includes encrypted configuration data for a storage array. In one embodiment, the authenticated token is accessed after it has been determined that the device that stores the token is within range of the storage array through a proximity detector as mentioned above. The authentication of the token may occur through any known authentication mechanism and include public-private key mechanisms, as well as single and multi-factor mechanisms. The storage array includes logic for token authentication in some embodiments. As noted above, the authenticated token may enable access to configuration data stored on the device to be configured or the configuration data may be downloaded over a secure connection between the device to be configured and a remote host storing the encrypted configuration data in alternative embodiments. In some embodiments, the physical presence of a phone or some other portable electronic device is part of multi-factor identification. The first factor is connecting, configuring an outgoing network and establishing a tunnel. The second factor is logging in through the established tunnel. In some embodiments, the logging in through the established tunnel can be used to enable “root” access by having a system phone home and generate temporary passwords for access. In some embodiments, a management console or commands associated with a specific role (like auditing data retention policy) is deliberate only exposed on demand to reduce attack vectors. At 303, the configuration data is decrypted through decryption logic of the storage array. In one embodiment, when the configuration data is decrypted, the decrypted data can be accessed for use in the configuration of the storage array. At 305, a configuration of the storage array is executed based on the configuration data. In one embodiment, a self-configuration component of a system for storage array self-configuration can be an integral part of the storage array executes the configuration of the storage array.

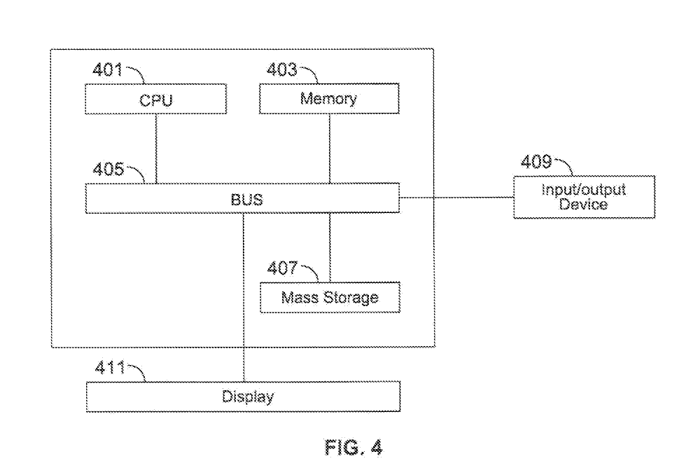

It should be appreciated that the methods described herein may be performed with a digital processing system, such as a conventional, general-purpose computer system. Special purpose computers, which are designed or programmed to perform only one function may be used in the alternative. FIG. 4 is an illustration showing an exemplary computing device which may implement the embodiments described herein. The computing device of FIG. 4 may be used to perform embodiments of the functionality for a storage node, a non-volatile solid state storage unit of the storage array, and/or system 101 of the storage array in accordance with some embodiments. The computing device includes a central processing unit (CPU) 401, which is coupled through a bus 405 to a memory 403, and mass storage device 407. Mass storage device 407 represents a persistent data storage device such as a disc drive, which may be local or remote in some embodiments. The mass storage device 407 could implement a backup storage, in some embodiments. Memory 403 may include read only memory, random access memory, etc. Applications resident on the computing device may be stored on or accessed via a computer readable medium such as memory 403 or mass storage device 407 in some embodiments. Applications may also be in the form of modulated electronic signals modulated accessed via a network modem or other network interface of the computing device. It should be appreciated that CPU 401 may be embodied in a general-purpose processor, a special purpose processor, or a specially programmed logic device in some embodiments.

Display 411 is in communication with CPU 401, memory 403, and mass storage device 407, through bus 405. Display 411 is configured to display any visualization tools or reports associated with the system described herein. Input/output device 409 is coupled to bus 405 in order to communicate information in command selections to CPU 401. It should be appreciated that data to and from external devices may be communicated through the input/output device 409. CPU 401 can be defined to execute the functionality described herein to enable the functionality described with reference to FIGS. 1-3. The code embodying this functionality may be stored within memory 403 or mass storage device 407 for execution by a processor such as CPU 401 in some embodiments. The operating system on the computing device may be MS-WINDOWS™, UNIX™, LINUX™, iOS™, CentOS™, Android™, Redhat Linux™, z/OS™, or other known operating systems. It should be appreciated that the embodiments described herein may be integrated with virtualized computing system also.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein. It should be appreciated that while the embodiments are described with regard to a storage array, the embodiments may be extended to any device having to be configured for installation or reconfigured and is not limited to a storage array.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” perform a task or tasks. In such contexts, the phrase “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method for storage array self-configuration, the method comprising:
accessing an authenticated token that comprises encrypted configuration data for a storage array;
decrypting the configuration data; and
based on the configuration data, executing with configuration executing components of the storage array, a configuration of the storage array, the executing responsive to authenticating the token.

2. The method of claim 1 wherein the accessing comprises detecting when the token is within a predetermined range of the storage array and wherein the method further comprises:
downloading the token into the storage array.

3. The method of claim 1 wherein the accessing comprises receiving the authenticated token via an audio jack.

4. The method of claim 1 wherein the accessing comprises accessing the token from a portable device.

5. The method of claim 1 wherein the authenticated token comprises encrypted data that determines a level of access to the storage array that ranges from limited to unlimited.

6. The method of claim 5 wherein the level of access is determined by a role associated with the encrypted data.

7. The method of claim 1 wherein the self-configuration is associated with one of an initialization of the array, a re-start of the array or an update of the array.

8. The method of claim 1 wherein the configuration process is updatable based on information included in the configuration data.

9. The method of claim 1 wherein the configuration process comprises determining if updates to the configuration have been already applied and whether additional updates are necessary.

10. A storage array comprising a self-configuration system, the self-configuration system comprising:
a token accessing component for accessing an authenticated token that comprises encrypted configuration data for the storage array; and
a configuration executing component for, based on the configuration data, executing a configuration of the storage array, wherein the executing is responsive to authentication of the token.

11. The storage array of claim 10 wherein the token accessing component comprises a token proximity detecting component for detecting when the token is within a predetermined range of the storage array.

12. The storage array of claim 10 wherein the token accessing component accesses the authenticated token via an audio jack.

13. The storage array of claim 10 wherein the token accessing component accesses the authenticated token from a portable device.

14. The storage array of claim 10 further comprising an access determining component for determining a level of access to the storage array based on encrypted data that indicates a level of access to the storage array that ranges from limited to unlimited.

15. The storage array of claim 14 wherein the data that determines a level of access to the storage array is associated with one or more roles.

16. The storage array of claim 10 further comprising:
a downloading component for downloading the token;
a decrypting component for decrypting the configuration data.

17. The storage array of claim 10 wherein self-configuration of the system is associated with one of an initialization of the array, a re-start of the array or an update of the array.

18. The method of claim 10 wherein the configuration process is updatable based on information included in the configuration data.

19. A solid state drive, the solid state drive comprising:
a controller; and
memory components, the memory components comprising a storage array comprising a self-configuration system, the self-configuration system comprising:
a token accessing component for accessing an authenticated token that comprises encrypted configuration data for the storage array; and
a configuration executing component for, based on the configuration data, performing a configuration of the storage array.

20. The solid state drive of claim 19, further comprising:
a downloading component for downloading the token;
a decrypting component for decrypting the configuration data; and
an access determining component for determining a level of access to the solid state drive based on encrypted data that indicates a level of access to the solid state drive that is included in the authenticated token.
